(19) United States
(12) Patent Application Publication
(10) Pub. No.: US 2015/0335201 A1
(43) Pub. Date: Nov. 26, 2015

(54) FRYER DEBRIS CATCHER

(71) Applicant: Frederick Hobbs, Haverhill, MA (US)

(72) Inventor: Frederick Hobbs, Haverhill, MA (US)

(21) Appl. No.: 14/283,580

(22) Filed: May 21, 2014

(51) Int. Cl. A47J 37/12

(52) U.S. Cl. CPC A47J 37/1295

(57) ABSTRACT

A fryer debris catcher to trap particles in a fryer vat comprising a basket, where the basket receives at least one fryer basket; a plurality of holes on every surface of the basket, where the plurality of holes drain oil in the fryer vat and catch the particles in the oil; and a handle extending from a rim of the basket, where the handle is coating in an insulating material. The fryer debris catcher may be coated in silicone or made from a molded silicone form.

### BACKGROUND OF THE INVENTION

1. Field of the Invention

The present invention relates to a filter that fits around a fryer basket to catch any food particles and debris that drifts into the oil before, during and after frying.

2. Description of Related Art

Restaurants and similar eating establishments frequently offer a variety of fried items to serve their customers. These food items are selected especially at fast food establishments because they are easy to make, and cheap to produce. Some places pride themselves on serving unique fried selections, ranging from fried Oreos, vegetables, candy bars and even Twinkies While these foods are easy to make and fun to eat, their equipment is typically challenging to clean and maintain. The crumbs from the fried foods often enter the vat or fryer, making the oil cloudy and dirty. Once too any particles are in the oil or have been in the oil for an extended period of time, the oil flavor changes due to all of the food pieces and burnt particles. To remove the particles the user must change the oil which can be an expensive, time consuming, messy and often dangerous process.

Typically, after cooking the user will use a skimmer or similar tool to fish out the food particles left in the vat after use. This is tedious because the pieces are so small and many remain in the vat until the oil in completely drained. Alternatively, some products have been developed to assist with particle collection. For example some fryers are equipped with drain filters to prevent the food and batter debris from settling into the drains and clogging the system. While these methods address some of the issues with food in the oil, they don't completely resolve the problem especially for oil flavor. Therefore, it would be beneficial in the art to provide a device that collects the food and debris left in a fryer vat after frying food.

### SUMMARY OF THE INVENTION

In view of the foregoing disadvantages inherent in the prior art, the general purpose of the present invention is to provide a fryer debris catcher to trap particles in a fryer vat, configured to include all of the advantages of the prior art, and to overcome the drawbacks inherent therein.

Accordingly, an object of the present invention is to provide a fryer debris catcher that includes a basket positioned at the bottom of a vat of fry oil to collect any food and debris that remains in the oil after the fryer baskets are removed.

To achieve the above objects, in an aspect of the present invention, a fryer debris catcher is described comprising a basket, where the basket receives at least one fryer basket; a plurality of holes on every surface of the basket, where the plurality of holes drain oil in the fryer vat and catch the particles in the oil; and a handle extending from a rim of the basket, where the handle is coating in an insulating material. The fryer debris catcher may be coated in silicone or made from a molded silicone form.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts an exploded perspective view of a fryer debris catcher in accordance with an exemplary embodiment of the present invention; and

FIG. 2 depicts a top view of a fryer debris catcher in accordance with an alternative embodiment of the present invention.

Like reference numerals refer to like parts throughout the description of several views of the drawings.

### DETAILED DESCRIPTION OF THE DRAWINGS

The present invention relates to a filter that receives a fryer basket to catch any food particles and debris that drifts into the oil before, during and after frying. The present invention provides a fryer debris catcher to constrain food and crumbs, and prevent them from reamining in the oil. The fryer debris catcher is a fine mesh basket supported with a peripheral edge and handle. The fryer debris catcher fits the size of full fryer vat systems to receive one, two, three or more fryer baskets. The fine mesh basket remains in the fry oil during cooking to catch all food particles that drift and escape the fry basket. Instead of the particles sinking to the bottom of the oil vat they are caught in the fryer debris catcher and removed often to maintain the fresh flavor of the oil and prevent damaging the fryer.

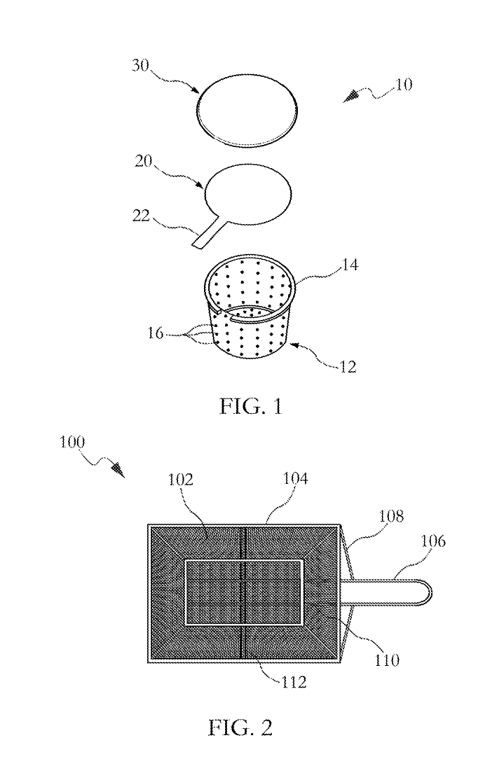

Turning now descriptively to the drawings, referring to FIG. 1, an exploded view of a fryer debris catcher 10 is shown in accordance with an exemplary embodiment of the present invention. The fryer debris catcher 10 includes a basket 12 with an upper rim 14. The basket 12 may be cylindrical with a circular rim 14. The basket 12 includes a plurality of holes 16 on every exterior surface. The holes 16 enable oil in a fryer vat to drain from the basket 12 yet are small enough to trap small particles and debris that escapes the fryer basket while cooking

A frame 20 fastens around the upper rim 14 of the basket 12. From the frame 20 extends a handle 22. The frame 20 envelops the rim 14 to enable the basket 12 to lower and rise from the fryer vat. The basket 12 may further include a lid 30 that rests upon the rim 14. The lid 30 prevents food from splattering from the fry basket and getting into the oil vat.

Referring now to FIG. 2, a top view of a fryer debris catcher 100 is shown in accordance with an alternative embodiment of the present invention. The fryer debris catcher 100 includes a fine mesh basket 102 to catch all food and debris that falls into the fryer vat. Around a top peripheral edge of the fine mesh basket 102 is a rim 104. The basket 102 may be a generally cuboidal shape with a rectangular rim 104. From the rim 104 is a handle 106 to enable lifting and lowering of the basket 102 from the fry oil. The handle 106 may be detachable as to not interfere with one or more fryer baskets that are positioned within the fine mesh basket 102 during use.

On each side of the handle 106 may be a pair of handle supports 108. The handle supports 108 prevent the handle 106 from bending or sliding when lifting the basket 102 from the oil. The handle 106 may further envelop the fine mesh basket 102 by continuing to a first basket support 110. The first basket support 110 extends the handle 106 material from the edge 104 connected to the handle 106 to the opposing edge 104. This way the basket 102 is supported on the sides and bottom with the first basket support 110. Likewise, a second basket support 112 may be positioned perpendicularly around the basket 102 to the first basket support 110.

The basket may be made from stainless steel and coated in an insulating material like silicone. The handle is stainless steel and is also coated in silicone to prevent overheating and enable safe handling. Alternatively, the basket may be completely made from a molded silicone form able to withstand and remain structurally sound in the high temperatures of the fryer vat. During use, fryer debris catcher is positioned at the bottom of a fry vat. Food items are then placed in the fry baskets, and then the fry baskets are lowered into the fryer debris catcher. The mesh or holes of the fryer debris catcher trap any food and particles in the oil and prevent them from dropping into the vat or drainage system. Once the food finishes cooking the fry basket is removed from the fryer debris catcher. The fryer debris catcher is then removed and emptied as often as deemed necessary by the user to maintain the flavor of the cooking oil.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A fryer debris catcher to trap particles in a fryer vat comprising:
a. a basket, where the basket receives at least one fryer basket;
b. a plurality of holes on every surface of the basket, where the plurality of holes drain oil in the fryer vat and catch the particles in the oil; and
c. a handle extending from a rim of the basket, where the handle is coating in an insulating material.

2. The fryer debris catcher according to claim 1, where the plurality of holes comprise a fine mesh.

3. The fryer debris catcher according to claim 1, where the basket is cubed with a rectangular rim.

4. The fryer debris catcher according to claim 1, where the basket is cylindrical with a circular rim.

5. The fryer debris catcher according to claim 1, where the handle is attached to a frame that supports the rim of the basket, where the frame is removable.

6. The fryer debris catcher according to claim 1, where the basket includes a first support, where the first support extends from the handle at one end of the basket to an opposing end.

7. The fryer debris catcher according to claim 6, where the basket includes a second support positioned perpendicularly from the first support around the basket.

8. The fryer debris catcher according to claim 1, where the basket and handle are made from stainless steel.

9. The fryer debris catcher according to claim 8, where the stainless steel basket is coated in silicone.

10. The fryer debris catcher according to claim 1, where the basket is made from a molded silicone form.

11. The fryer debris catcher according to claim 1, where the basket includes a lid to prevent particles from leaving the fryer basket.
